(19) United States
(12) Patent Application Publication
(10) Pub. No.: US 2020/0029483 A1
(43) Pub. Date: Jan. 30, 2020

(54) Blade Trip System

(71) Applicant: Summers Manufacturing Company, Inc., Devils Lake, ND (US)

(72) Inventor: Douglas R. Lee, Devils Lake, ND (US)

(21) Appl. No.: 16/044,702

(22) Filed: Jul. 25, 2018

(51) Int. Cl. A01B 61/04; A01B 33/02

(52) U.S. Cl. CPC A01B 61/046; A01B 33/024

(57) ABSTRACT

A blade trip system which allows a blade to adjust upwardly to safely pass over an obstruction and then revert downwardly after passing over the obstruction without damaging the blade or frame. The blade trip system generally includes a coupler connected to an implement; with the implement being adapted to traverse a ground surface. An arm may be rotatably connected at its first end to the coupler. The second end of the arm may be connected to a blade; with the blade being adapted to cut the ground surface. A biasing device connected between the arm and coupler is adapted to bias the arm away from the coupler. The arm is adapted to rotate upwardly toward the coupler to a raised position when the blade contacts an obstruction in the ground surface and rotate downwardly away from the coupler to a lowered position after the blade has passed over the obstruction.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to a blade trip system which allows a blade to adjust upwardly to safely pass over an obstruction and then revert downwardly after passing over the obstruction without damaging the blade or frame.

### Related Art

Any discussion of the related art throughout the specification should in no way be considered as an admission that such related art is widely known or forms part of common general knowledge in the field.

Various blades have been in use for cutting into a ground surface in a wide range of industries, including in construction, roadwork, agriculture, farming, and the like. Such blades will generally be driven across the ground surface such that the blades may cut into the ground surface, such as to leave a trough in which seeds may be dispersed or the like.

When using such blades for various purposes, the blades will often come into contact with various obstructions in the ground surface, such as debris, rocks, or the like. In the past, blades have suffered damage due to striking such obstructions if not properly configured to adjust automatically upon contacting an obstruction. While spring-based systems have been introduced previously, these systems often suffer from numerous shortcomings that can affect the operation of the overall system of which the blade is a part.

### SUMMARY

An example embodiment is directed to a blade trip system. The blade trip system includes a coupler which may be connected to an implement; with the implement being adapted to traverse a ground surface. An arm may be rotatably connected at its first end to the coupler. The second end of the arm may be connected to a blade; with the blade being adapted to cut the ground surface. A biasing device connected between the arm and coupler is adapted to bias the arm away from the coupler. The arm is adapted to rotate upwardly toward the coupler to a raised position when the blade contacts an obstruction in the ground surface and rotate downwardly away from the coupler to a lowered position after the blade has passed over the obstruction.

There has thus been outlined, rather broadly, some of the embodiments of the blade trip system in order that the detailed description thereof may be better understood, and in order that the present contribution to the art may be better appreciated. There are additional embodiments of the blade trip system that will be described hereinafter and that will form the subject matter of the claims appended hereto. In this respect, before explaining at least one embodiment of the blade trip system in detail, it is to be understood that the blade trip system is not limited in its application to the details of construction or to the arrangements of the components set forth in the following description or illustrated in the drawings. The blade trip system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1A is a perspective view of a blade trip system installed on an implement towed by a tractor in accordance with an example embodiment.

FIG. 1B is a perspective view of a blade trip system in accordance with an example embodiment.

FIG. 2 is a perspective view of a blade trip system in accordance with an example embodiment.

FIG. 3 is a front view of a blade trip system in accordance with an example embodiment.

FIG. 4 is a rear view of a blade trip system in accordance with an example embodiment.

FIG. 5 is a side sectional view of a blade trip system including a pivot shaft in accordance with an example embodiment.

FIG. 6 is a side sectional view of a blade trip system in accordance with an example embodiment.

FIG. 7A is a side view of a blade trip system approaching an obstruction in accordance with an example embodiment.

FIG. 7B is a side view of a blade trip system going over an obstruction in accordance with an example embodiment.

FIG. 7C is a side view of a blade trip system after passing over an obstruction in accordance with an example embodiment.

FIG. 8A is a side view of a blade trip system approaching an obstruction in accordance with an example embodiment.

FIG. 8B is a side view of a blade trip system going over an obstruction in accordance with an example embodiment.

FIG. 8C is a side view of a blade trip system after passing over an obstruction in accordance with an example embodiment.

FIG. 9A is a side view of a biasing device of a blade trip system at a first preload in accordance with an example embodiment.

FIG. 9B is a side view of a biasing device of a blade trip system being adjusted to a second preload in accordance with an example embodiment.

FIG. 10A is a side view of a biasing device of a blade trip system at a first preload in accordance with an example embodiment.

FIG. 10B is a side view of a biasing device of a blade trip system being adjusted to a second preload in accordance with an example embodiment.

FIG. 11 is a perspective view of a blade trip system installed on an implement in accordance with an example embodiment.

### DETAILED DESCRIPTION

### A. Overview.

An example blade trip system 10 generally comprises a coupler 30 adapted to be connected to an implement 14; with the implement 14 being adapted to traverse a ground surface 18, and an arm 40 comprising a first end 41 and a second end 42, wherein the first end 41 of the arm 40 is rotatably connected to the coupler 30 to rotate in either a first rotational direction or a second rotational direction. The second end 42 of the arm 40 may be connected to a blade 60 adapted to cut the ground surface 18. A biasing device 50 may be connected between the coupler 30 and the arm 40; with the biasing device 30 being resiliently compressible in a linear manner so as to bias the arm 40 in the second rotational direction. The arm 40 may comprise a first portion 47 and a second portion 48, wherein the first portion 47 is connected to the coupler 30 and the second portion 48 is connected to the blade 60; with the second portion 48 extending rearwardly from the first portion 47. The coupler 30 may be connected to an agricultural implement 14.

The arm 40 may be adapted to rotate in the first rotational direction toward the coupler 30 to a raised position when the blade 60 contacts an obstruction 19 in the ground surface 18 such that the blade 60 passes over the obstruction 19. The arm 40 may also be adapted to rotate in the second rotational direction away from the coupler 30 to a lowered position after the blade 60 has passed over the obstruction 19.

The blade 60 may comprise a disc coulter. The preload of the biasing device 50 may be adapted to be adjusted, such as by a bolt 55 for adjusting the preload of the biasing device 50. The bolt 55 may be adapted to be tightened to increase the preload of the biasing device 50 or loosened to decrease the preload of the biasing device 50. The biasing device 50 may comprise a plurality of conical spring washers 54 positioned upon the bolt 55. The biasing device 50 may comprise a nut 58 for adjusting a preload of the biasing device 50. A nut 58 may be threadably connected to the bolt 55 and adapted to selectively bear against the plurality of conical spring washers 54.

The biasing device 50 may comprise a resiliently compressible member 53. The resiliently compressible member 53 may be elongated and compressible along a longitudinal axis thereof. The resiliently compressible member 53 may be comprised of urethane. The resiliently compressible member 53 may comprise a cylinder, such as a urethane cylinder.

The biasing device 50 may comprise an elongated resiliently compressible member 53 positioned upon the bolt 55. A nut 58 may be threadably connected to the bolt 55 and adapted to selectively bear against the elongated resiliently compressible member. The biasing device 50 may comprise a plurality of conical spring washers 54. The conical spring washers 54 may be arranged in a series configuration, with each of the plurality of conical spring washers 54 being concentrically aligned.

### B. Coupler.

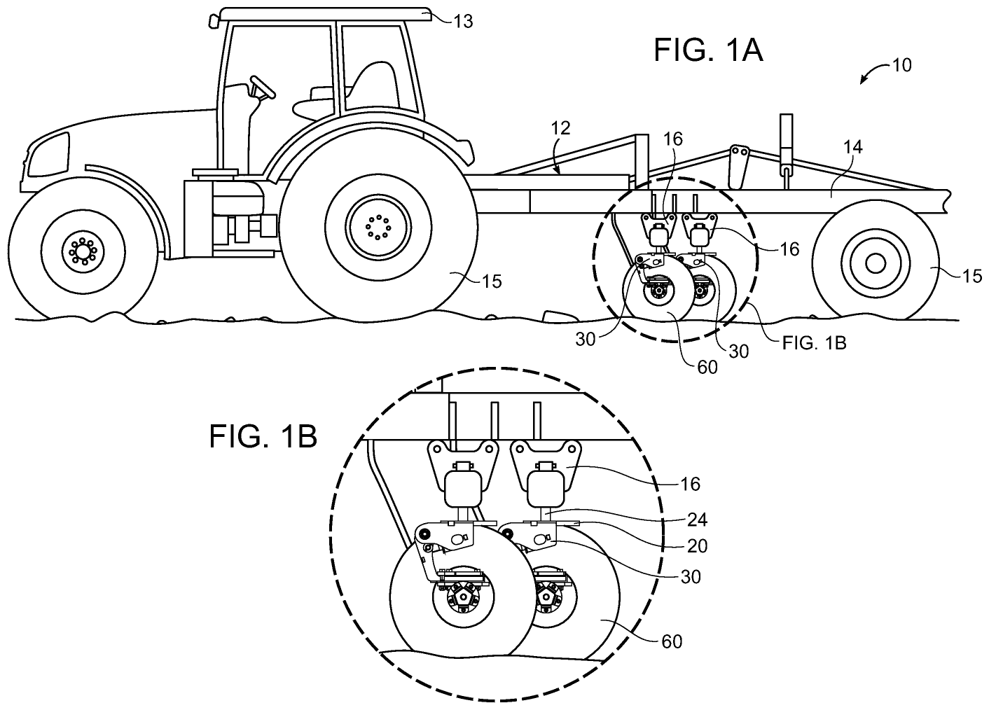

As shown throughout the figures, the blade trip system 10 may be used in conjunction with a planting system 12. The systems and methods described herein may also be utilized in conjunction with a wide range of agricultural, construction, and/or landscaping systems, such as ditch diggers, ground spreaders, and the like. Typically, the blade trip system 10 may be used in connection with an implement 14, such as one which is drawn across the ground surface 18 by a tractor 13 as shown in FIG. 1A.

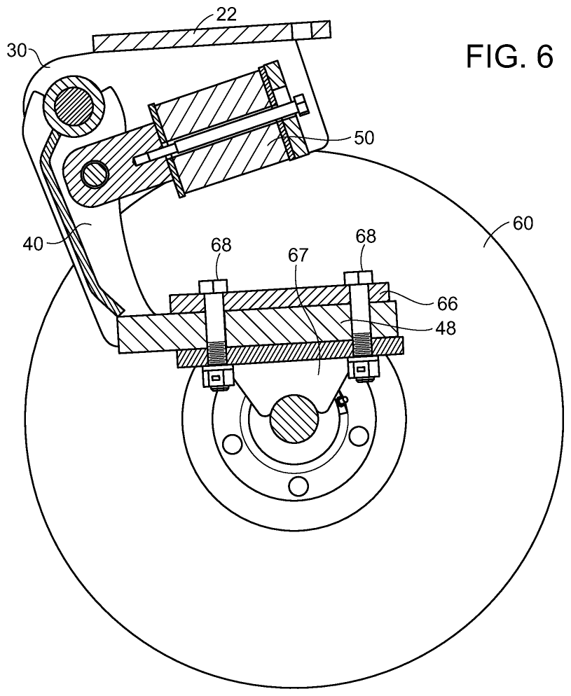

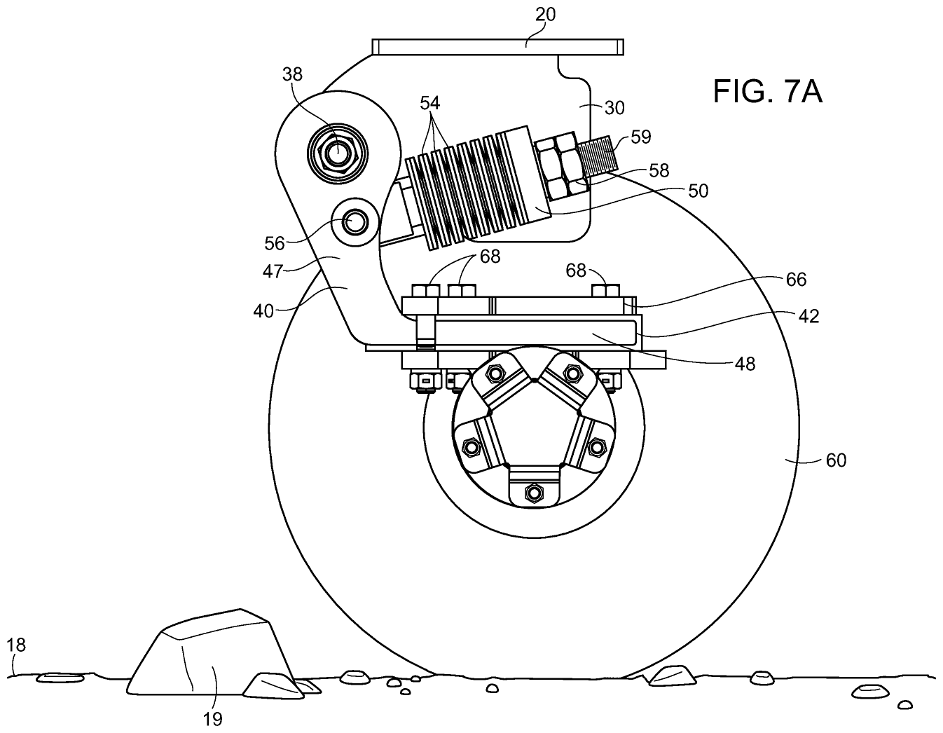

As best shown in FIG. 6, a mount 20 may be utilized to interconnect the coupler 30 with the implement 14. The mount 20 may comprise a bracket, connector, linkage, or the like which is connected to the implement 14 to support the coupler 30. Any method or device known in the art to connect a part to an implement 14 may be utilized, and the exemplary embodiments shown in the figures should not be construed as limiting.

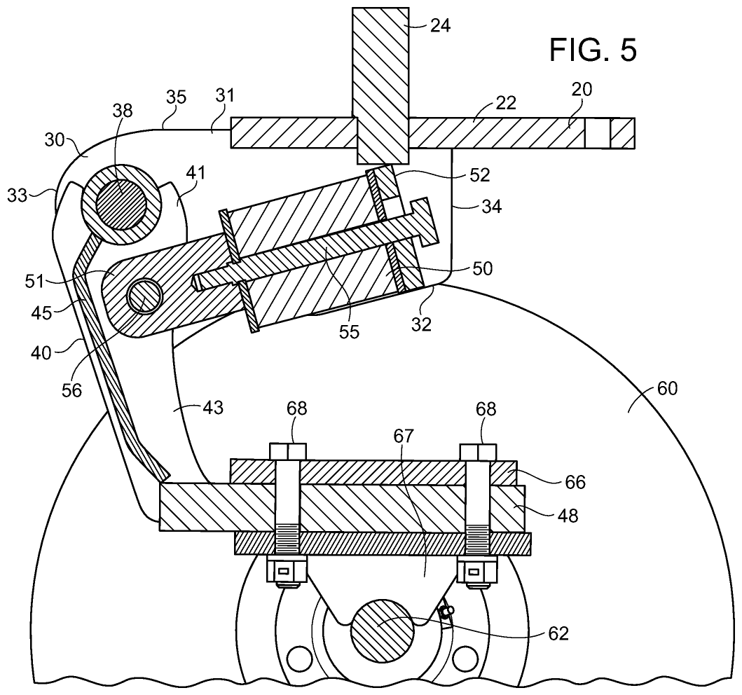

FIG. 6 illustrates a plate 22 which is connected to the implement 14. In some embodiments, the plate 22 may be omitted, and the coupler 30 directly connected to the implement 14. In the exemplary embodiment of FIG. 6, the plate 22 is secured to the implement 14 directly. In other embodiments, such as shown in FIG. 5, the mount 20 may include a pivot shaft 24 which is connected to the implement 14 such that the mount 20 may rotate. Although not shown, actuators such as hydraulic actuators may be utilized for control of positioning of the mount 20 and, by extension, the coupler 30 to which it is connected to.

As shown in FIG. 1B, a coupler 30 is connected to the implement 14, such as by the mount 20 described above. In other embodiments, the coupler 30 may be directly connected to the implement 14, or even integrally formed therewith (e.g., the coupler 30 could be formed from the frame of the implement 14). The coupler 30 may act as a trip; with the arm 40 being rotatably connected to the coupler 30 such that the arm 40 may rotate with respect to the coupler 30 to lift or lower the blade 60 as described herein.

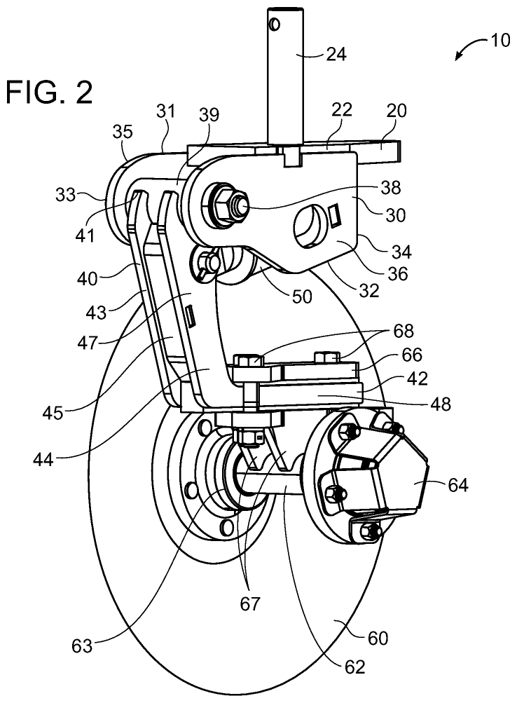

The shape, size, and configuration of the coupler 30 may vary in different embodiments. In the exemplary embodiment shown in FIG. 2, the coupler 30 is illustrated as comprising an upper end 31, a lower end 32, a first end 33, a second end 34, a first side 35, and a second side 36. The coupler 30 may be connected at its upper end 31 to the implement 14, such as by a mount 20.

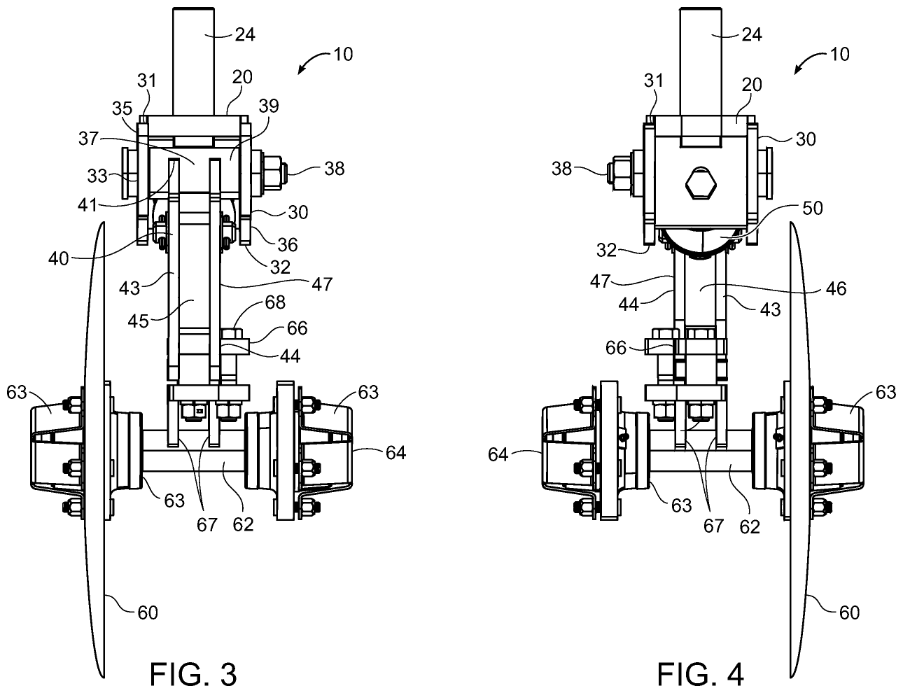

As shown in FIGS. 2-4, the coupler 30 may comprise a bracket configuration with an inverted U-shape. The coupler 30 may comprise an opening 37 which is defined between its first side 35 and second side 36. The biasing device 50 may be positioned within the opening 37 such as shown in FIGS. 3-4. A pivot pin 38 may extend between the first and second sides 35, 36 of the coupler 30 at or near its first end 33 such as shown in FIG. 2. The pivot pin 38 may form a hinge 39 by which the arm 40 may be rotatably connected to the coupler 30.

### C. Arm.

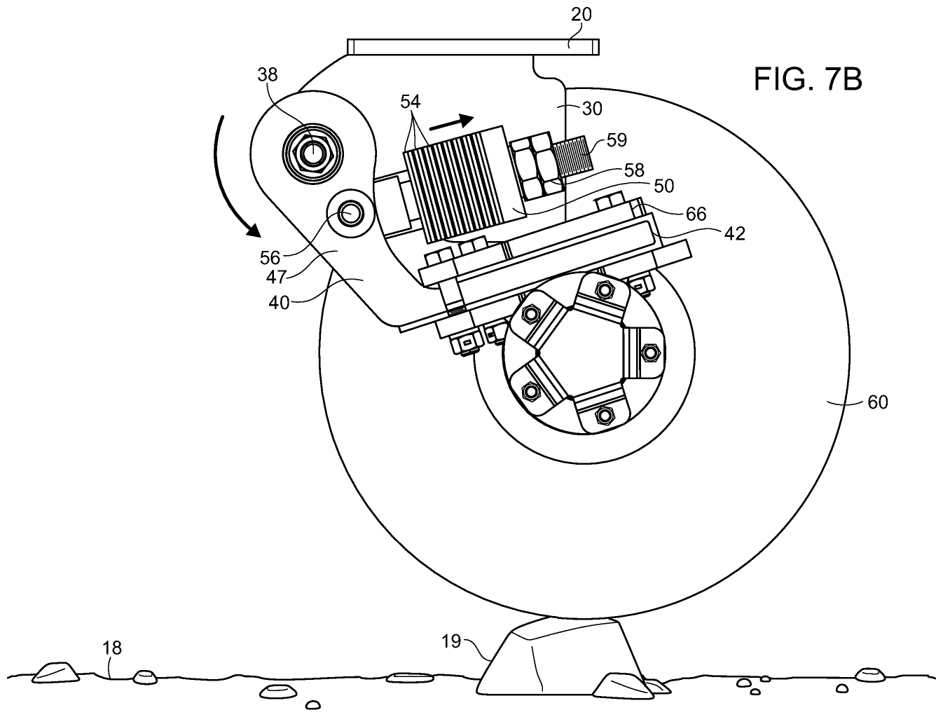

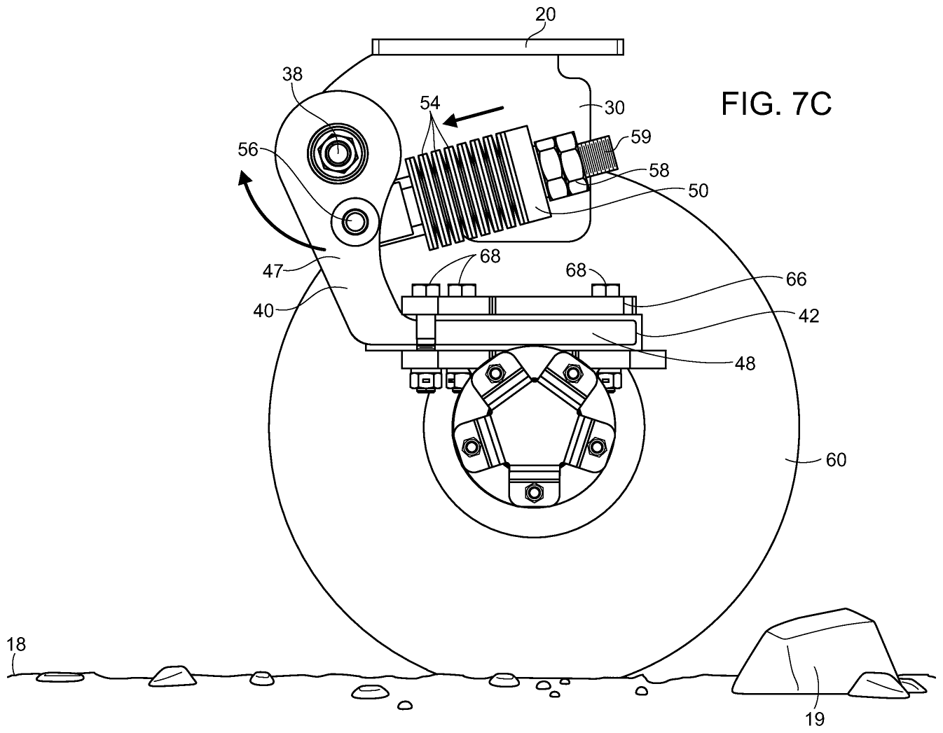

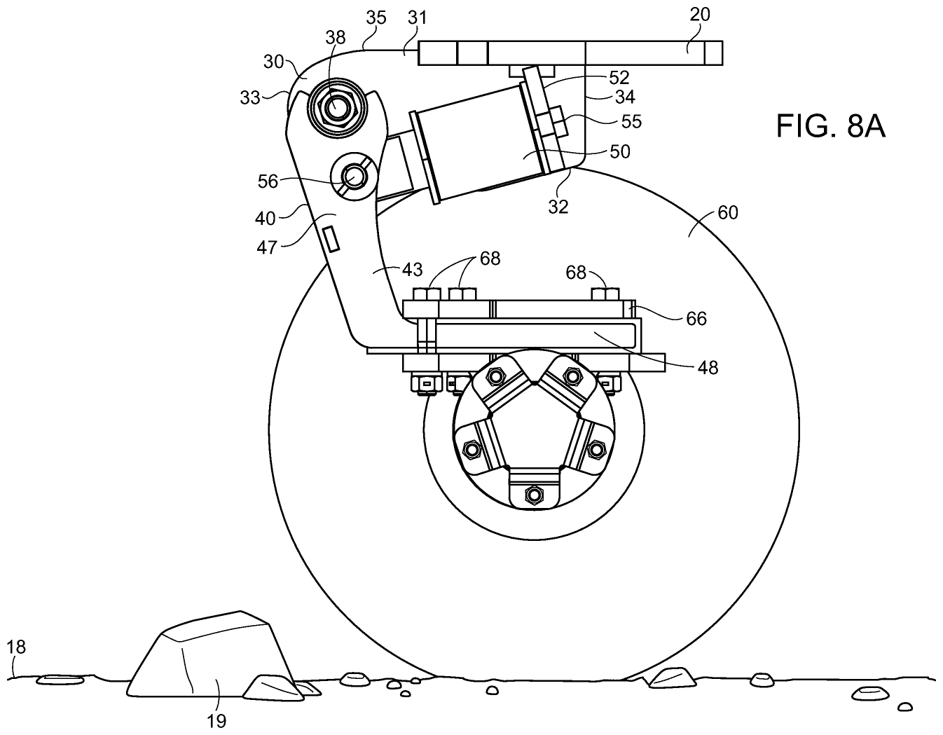

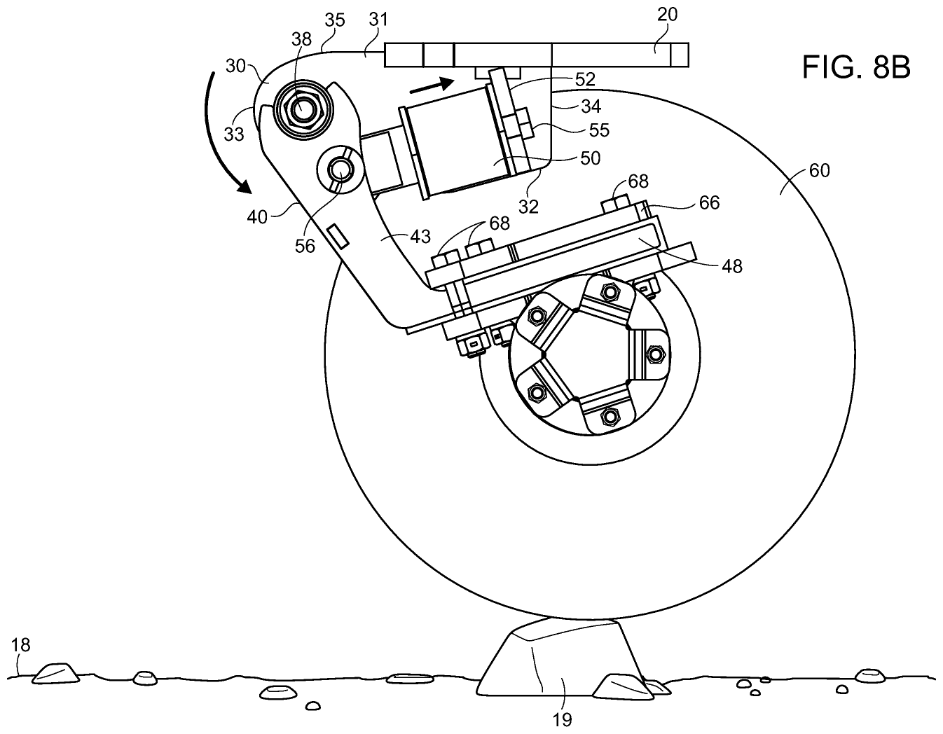

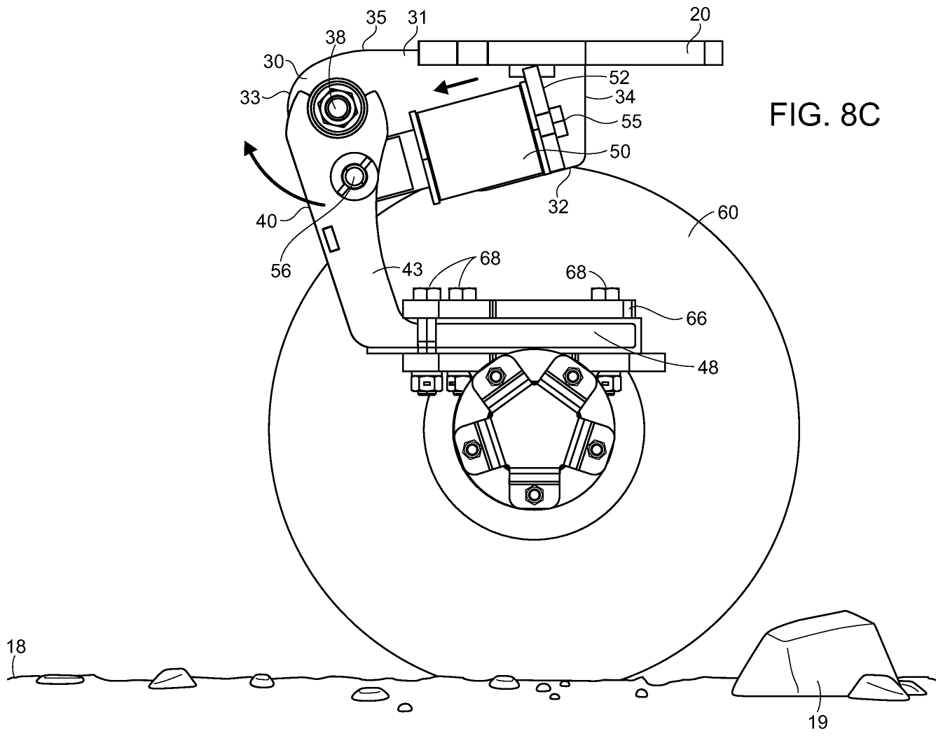

As shown in FIGS. 7 and 8, an arm 40 may be rotatably connected to the coupler 30. The arm 40 may be adapted to rotate in a first direction or a second direction with respect to the coupler 30. In the exemplary embodiments shown in FIGS. 7 and 8, the arm 40 may rotate either upwardly toward the coupler 30 (first direction) or downwardly away from the coupler 30 (second direction). The biasing device 50 may be connected between the arm 40 and the coupler 30 so as to bias the arm 40 toward a rested position.

The shape, size, and configuration of the arm 40 may vary in different embodiments. In the exemplary embodiment shown in FIG. 2, the arm 40 is illustrated as comprising a first end 41, a second end 42, a first side 43, and a second side 44. The first and second sides 43, 44 of the arm 40 may define an opening 46 such as shown in FIG. 4. A wall 45 may extend across part or all of the opening 46 such as shown in FIG. 2.

The first end 41 of the arm 40 may be rotatably connected to the coupler 30 such as shown in FIG. 2. A pivot pin 38 is shown in FIGS. 2-4 which forms a hinge 39 between the first end 33 of the coupler 33 and the first end 41 of the arm 40. As best illustrated in FIGS. 7B and 8B, the arm 40 may pivot or rotate upwardly in a first direction toward the coupler 30 or downwardly in a second direction away from the coupler 30.

The second end 42 of the arm 40 may be connected to the blade 60 such as shown in FIG. 2. The manner in which the arm 40 is interconnected with the blade 60 may vary in different embodiments, and should not be construed as limited by the exemplary figures. In the exemplary embodiment shown in FIG. 2, the second end 42 of the arm 40 is connected to a disc mount 66, such as with fasteners 68. The disc mount 66 is itself connected to the axle 62 of the blade 60 so as to apply upward force on the arm 40 when the blade 60 is pushed upwardly over an obstruction.

As shown in FIG. 5, the arm 40 may comprise a first portion 47 and a second portion 48. The first portion 47 of the arm 40 may include the first end 41 of the arm 40 which is rotatably connected to the coupler 30 or, in some embodiments, directly to the implement 14. The second portion 48 of the arm 40 may include the second end 42 of the arm 40 which is connected to the blade 60. As shown in FIG. 5, the second portion 48 of the arm 40 may be oriented at a right angle with respect to the first portion 47 of the arm 40. In the illustrated exemplary embodiment, the first portion 47 of the arm 40 extends substantially downwardly, while the second portion 48 of the arm 40 extends substantially perpendicularly with respect to the first portion 47 of the arm 40 to form an L-shaped configuration. Such a configuration ensures that the arm 40 pivots upwardly toward the coupler 30 against the bias force of the biasing device 50 such as shown in FIG. 6B.

The manner in which the arm 40 pivots with respect to the coupler 30 may vary in different embodiments. In the exemplary embodiments shown in the figures, both the first and second portions 47, 48 rotate together with respect to the coupler 30. In some embodiments, the first portion 47 may remain fixed while the second portion 48 rotates, or vice versa.

### D. Biasing Device.

As shown in FIGS. 5 and 6, a biasing device 50 may be connected between the coupler 30 and the arm 40 so as to exert a bias force against the arm 40. In some embodiments in which a coupler 30 is omitted, the biasing device 50 may be connected between the arm 40 and the implement 14. The biasing device 50 is preferably adapted to apply a bias force to the arm 40 such that the arm 40 is biased away from the coupler 30 toward a downward position. When the blade 60 contacts an obstruction, the biasing device 50 will be compressed as the arm 40 pivots toward the coupler 30 into a raised position. After passing over the obstruction 19, the biasing device 50 will return the arm 40 to its original, lowered position.

As shown in FIGS. 5 and 6, the biasing device 50 may comprise a first end 51 and as second end 52. The first end 51 of the biasing device 50 may be connected to the arm 40. In the embodiment shown in FIG. 5, the first end 51 of the biasing device 50 is pivotally connected to the arm 40 by a pivot pin 56. The second end 52 of the biasing device 50 is illustrated as connected to the coupler 30. Force applied by the arm 40 will cause the first end 51 of the biasing device 50 to compress towards the second end 52 of the biasing device 50. In some embodiments, the biasing device 50 may be adapted to adjust a preload applied against the arm 40. In the embodiment shown in FIG. 5, a bolt 55 is shown extending through the biasing device 50. Such a bolt 55 may be utilized to adjust the preload of the biasing device 50 by tightening the bolt 55 to increase preload and loosening the bolt 55 to decrease preload. Alternatively, multiple bolts 55 could be utilized; with each of the bolts 55 comprising different lengths.

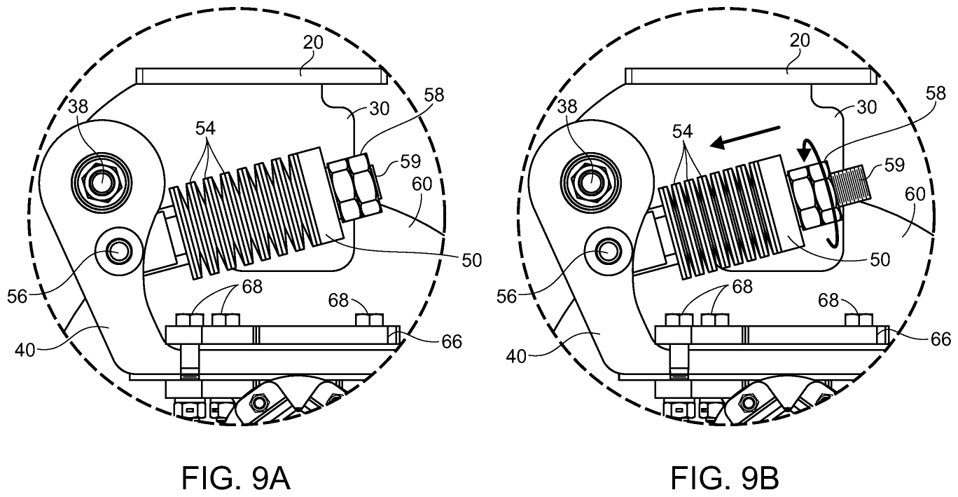

Different bolts 55 could be selected and interchanged to adjust the preload of the biasing device 50. For example, a shorter bolt 55 may be utilized for more preload and a longer bolt 55 could be utilized for less preload. In an exemplary embodiment shown in FIGS. 7A, 7B, and 7C, the biasing device 50 may include a threaded shaft 59 on which one or more nuts 58 are adjustably connected. The nuts 58 may be tightened to increase preload or loosened to decrease preload such as shown in FIGS. 9A and 9B. When the nuts 58 are tightened, they may bear against the biasing device 50 so as to increase preload in the biasing device 50 such as shown in FIG. 9B.

It should be appreciated that a wide range of biasing devices 50 may be utilized with the systems and methods described herein. In the exemplary embodiment shown in FIGS. 5, 6, 8, and 10, the biasing device 50 is illustrated as comprising a resiliently compressible member 53. In the exemplary embodiment shown in FIGS. 7 and 9, the biasing device 50 is illustrated as comprising a plurality of washers 54. In either case, the biasing device 50 applies a bias force against the arm 40 such that the arm 40 remains in its lowered position absent application of upward force sufficient to overcome the preload of the biasing device 50, such as from an obstruction 19 in the ground surface 18.

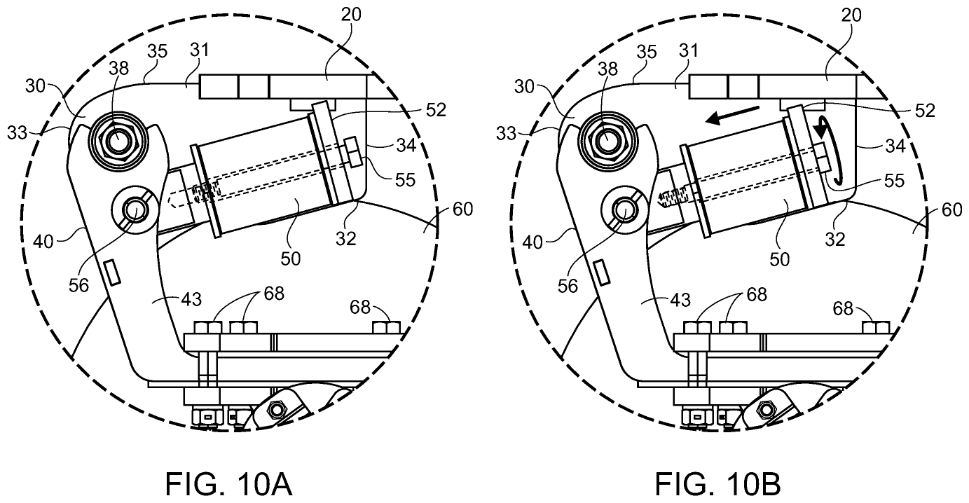

FIGS. 5, 7, 8, and 10 illustrate an exemplary embodiment utilizing one or more resiliently compressible members 53 such as, but not limited to, a urethane cylinder. In such an embodiment, resiliently compressible material, such as urethane, polyurethane, rubber, plastic, or the like, is connected between the arm 40 and the coupler 30 such as shown in FIG. 5. The resiliently compressible material may be arranged to form a cylindrical shape such as shown in the figures, or other shapes may be utilized such as, but not limited to, a cube shape. The resiliently compressible member 53 may be connected within a bracket or other housing and may be secured to the coupler 30 and/or arm 40 via fasteners, clamps, a pivot pin 56 such as shown in FIG. 5, or other devices known in the art. As shown in FIG. 5, a bolt 55 may extend through the resiliently compressible member 53. The bolt 55 may pre-preload the resiliently compressible member 53 by applying pressure to compress the resiliently compressible member 53 when in its rested position (no pressure being applied from the arm 40). The bolt 55 may be adjusted such as shown in FIGS. 10A and 10B, or different-sized bolts 55 may be provided with longer bolts 55 applying less preload to the resiliently compressible member 53 and shorter bolts 55 applying more preload to the resiliently compressible member 53.

FIGS. 7 and 9 illustrate an exemplary embodiment utilizing a plurality of washers 54. In such an embodiment, a plurality of washers 54 are arranged so as to form the biasing device 50 such as shown in FIG. 7A. Various types of washers 54 known in the art to form a biasing device 50 when stacked or otherwise arranged together may be utilized, such as, but not limited to, Belleville washers, conical spring washers, disc springs, cupped spring washers, and/or coned-disc springs.

As shown in FIG. 7A, the washers 54 may be arranged around a threaded shaft 59 in various configurations such as, but not limited to, a single disk, parallel, series, series-parallel or combinations thereof (e.g. four washers 54 arranged together in a series configuration and eight washers 54 arranged together in a series-parallel configuration). FIGS. 7A through 7C illustrate an exemplary embodiment wherein the washers 54 are comprised of conical spring washers arranged in a series configuration. A pair of nuts 58 is shown being threadably connected to the threaded shaft 59 such that the nuts 58 may be adjusted away from or toward the washers 54. Although a pair of nuts 58 are shown, it should be appreciated that more or less nuts 58 may be utilized in different embodiments. In the exemplary embodiment shown in FIGS. 9A and 9B, the nuts 58 may be tightened to bear against the washers 54 and compress them toward the arm 40 so as to apply pre-preload to the biasing device 50. Alternatively, the nuts 58 may be loosened to release pressure against the washers 54 and thus decrease the force necessary to overcome the bias force applied by the biasing device 50.

### E. Blade.

The systems and methods described herein will generally be used in connection with a blade 60 which is adapted to cut into the ground surface 18. It should be appreciated that the disk trip system 10 may be utilized with a wide range of types of blades 60, and should not be construed as limited by the exemplary figures which merely show an exemplary embodiment.

The systems and methods described herein may be utilized with any type of use in which a blade 60 is cutting into a ground surface 18 which may include obstructions 19, including but not limited to construction, agriculture, landscaping, farming, roadwork, and the like. The blade 60 may be a component of a planting system 10, such as an air seeder system, or other agricultural implement. The blade 60 may be manually driven or mechanically driven, such as by a tractor 13 as shown in FIG. 1A.

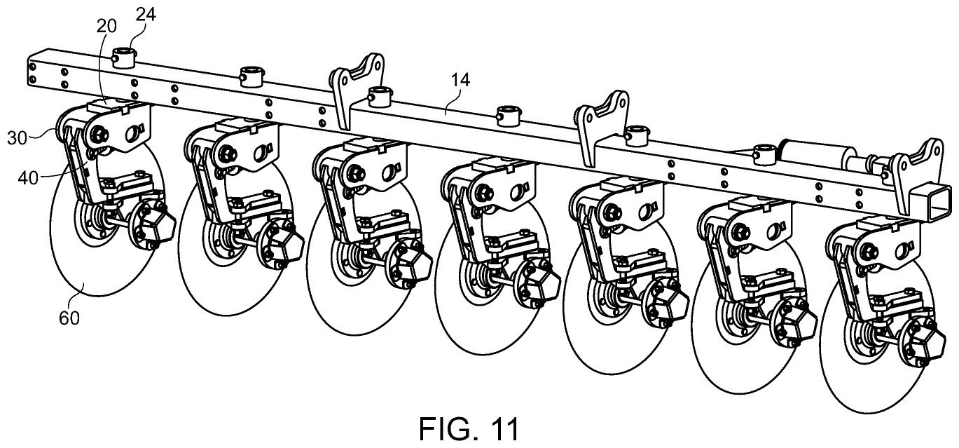

FIGS. 1A, 1B, and 11 illustrate an exemplary blade 60 connected to an implement 14 by a coupler 30 and arm 40. In the exemplary embodiment shown in the figures, the blade 60 is illustrated as comprising a disc coulter. The blade 60 should not be construed as limited to a disc structure, as it could comprise various other devices such as a shovel configuration, or any other type of projection known to traverse and cut into a ground surface 18. The blade 60 may also be comprised of various other types of ground penetrating devices such as, but not limited to, seed openers, seed disc openers, plow blades, disc blades, coulter blades, ripper points, tillage blades, cultivator sweeps, cultivator shovels, furrower point, plow point, and the like.

The blade 60 will generally be connected to the arm 40 such that the blade 60 applies an upward force on the arm 40 when passing over an obstruction 19 in the ground surface 18 as shown in FIGS. 8B and 9B. The manner in which the blade 60 is connected to the arm 40 may vary in different embodiments. In some embodiments, the blade 60 may be directly connected to the arm 40 (e.g., the blade 60 could be rotatably connected to the arm 40).

In the exemplary embodiment shown in FIGS. 3 and 4, the arm 40 is illustrated as being connected to an axle 62 of the blade 60. The axle 62 is shown as connected to a bearing 63 of the blade 60 such that the blade 60 may rotate bout the axle 62. An end member 64, which could also comprise a bearing in some embodiments, is shown as connected at the distal end of the axle 62.

As shown in FIG. 7A, the second portion 48 of the arm 40 extends parallel with the ground surface 18 when in the lowered position. The second portion 48 of the arm 40 may be connected to the blade 60, such as via a blade mount 66 as best shown in FIG. 7A. The blade mount 66 may comprise a bracket or the like which connects to the arm 40, such as via fasteners 68.

A pair of linkages 67 is shown as connecting the blade mount 66 to the axle 62 of the blade 60. Various other configurations may be utilized in different embodiments to effectuate the connection between the blade 60 and the arm 40, so long as upward motion of the blade 60 will be applied as an upward force on the arm 40.

### F. Operation of Preferred Embodiment.

In use, the disk trip system 10 may be used with any range of applications. The exemplary figures illustrate embodiments utilized in connection with a planting system 12 in which a blade 60 cuts into a ground surface 18. FIGS. 1A and 1B illustrate blades 60 being supported by arms 40 which are connected to an implement 14; the implement 14 being towed by a tractor 13. FIG. 11 illustrates a plurality of blades 60 being connected to a single implement 14 in a row as is common in planting systems 12.

It should be appreciated that these are merely exemplary uses of the blade trip system 10 and that a wide range of other uses may be accomplished by the methods and systems described herein. For example, any blade 60 which, in use, would potentially contact obstructions 19 could benefit from use of the pivoting arm 40 and biasing device 50 described herein.

In use, the coupler 30 may first be connected to the implement 14. However, in some embodiments, the arm 40 may be directly (and rotatably) connected to the implement 14. In the embodiments shown in the figures, the coupler 30 may be connected to the implement 14 by a mount 20, such as a plate 22 as shown in FIG. 7A. In such embodiments, the coupler 30 may be fixed in place.

In other embodiments, the coupler 30 may be connected to the implement 14 by a pivot shaft 14 which allows the coupler 30 to rotate with respect to the implement 14 such as shown in FIG. 11. As illustrated, such an exemplary embodiment may utilize vertical pivot shafts 24 which are rotatably connected to the implement 14. The pivot shaft 24 may be connected to the coupler 30 directly, or by a mount 20 such as shown in FIG. 11. In some embodiments, hydraulic actuators (not shown) may be utilized to control and adjust positioning of the coupler 30 with respect to the implement 14.

As shown in FIG. 2, the arm 40 may be rotatably connected to the coupler 30, such as by a pivot pin 38. In the exemplary embodiment shown in the figures, the first end 41 of the arm 40 is shown as rotatably connected to the first end 33 of the coupler 30. The arm 40 may thus rotate upwardly toward the coupler 30 in a first direction or downwardly away from the coupler 30 in a second direction. The biasing device 50 ensures that, absent application of force, the arm 40 remains in its lowered position. Application of upward force on the blade 60 causes the arm 40 to rotate upwardly toward the raised position so as to safely pass over an obstruction 19 without damaging the coupler 30, arm 40, blade 60, or implement 14.

The second end 42 of the arm 40 may be connected to the blade 60. FIG. 2 illustrates that the second portion 48 of the arm 40 extends substantially perpendicularly with respect to the first portion 47 of the arm 40. The second portion 48 may extend rearwardly from the first portion 47 as shown in the figures. By way of example, the arm 40 may comprise a substantial L-shape. When the arm 40 is in the lowered position, the first portion 47 of the arm 40 may extend substantially vertically and the second portion 48 of the arm 40 may extend substantially horizontally such as shown in FIG. 5.

The arm 40 may be connected to the blade 60 in any number of manners known in the art. In the exemplary embodiment shown in the figures, the second portion 48 of the arm 40 is secured by a blade mount 66. Linkages 67 extend downwardly from the blade mount 66 to connect to the axle 62 of the blade 60 such that upward force on the blade 60 will be translated through the blade mount 67 to the arm 40. If the upward force is sufficient to overcome the preload of the biasing device 50, the arm 40 will rotate toward the coupler 30.

The preload of the biasing device 50 may be adjusted for different applications. For example, stronger blades 60 may work more efficiently with a higher preload in the biasing device 50 since stronger blades 60 can break through smaller obstructions 19. A weaker blade 60 will benefit from a lower preload in the biasing device 50 such that even smaller obstructions 19 will overcome the preload and allow the arm 40 to rotate.

Different types of ground surfaces 18 having different kinds of obstructions 19 may also warrant different preloads for the biasing device 50 to allow for optimal and efficient operations. FIGS. 10A and 10B illustrate a first method of adjusting the preload of the biasing device 50 in which a bolt 55 extending through the biasing device 50 may be tightened to increase preload or loosened to decrease preload.

Alternatively, multiple bolts 55 having different lengths may be provided; with a bolt 55 of a specific length being used for a specific preload. For example, a longer bolt 55 may be utilized for lesser preload, and a shorter bolt 55 may be utilized for increased preload. FIGS. 9A and 9B illustrate an alternate method of adjusting the preload of the biasing device 50. As shown, the biasing device 50 may be connected around a threaded shaft 59. One or more nuts 58 are threadably engaged on the threaded shaft 59 outside of the biasing device 50.

Adjusting the nuts 58 toward the biasing device 50 will cause the nuts 58 to bear against the biasing device 50 to increase preload in the biasing device 50. Adjusting the nuts 58 away from the biasing device 50 will cause the nuts 58 to apply less force against the biasing device 50 to decrease preload in the biasing device 50. It should be appreciated that any other method known in the art to increase or decrease preload in a biasing device 50 may be utilized.

With the coupler 30 connected to the implement 14, the arm 40 rotatably connected to the coupler 30, a biasing device 50 connected between the coupler 30 and arm 40, and a blade 60 connected to the arm 40, the blade trip system 10 is ready for use. FIGS. 7A, 7B, 7C, 8A, 8B, and 8C illustrate usage of the blade trip system 10 in passing over an obstruction 19. FIGS. 8A, 8B, and 8C illustrate usage with a biasing device 50 comprised of a resiliently compressible member 53 and FIGS. 7A, 7B, and 7C illustrate usage with a biasing device 50 comprised of a plurality of washers 54.

As shown in the figures, the blade 60 will cut into the ground surface 18 as the blade 60 traverses the ground surface 18. FIG. 7A illustrates the blade 60 approaching an obstruction 19 in the ground surface 18. When the blade 60 contacts the obstruction 19, an upward force will be applied to the arm 40 and the arm 40 will rotate upwardly into a raised position such that the blade 60 may safely pass over the obstruction 19 as shown in FIG. 7B. The biasing device 50 will continue to apply a downward pressure on the blade 60 such that, after passing over the obstruction 19, the arm 40 lowers back into its lowered position such as shown in FIG. 7C.

As shown in FIGS. 8A, 8B, and 8C, when the blade 60 contacts the obstruction 19, an upward force is applied to the second portion 48 of the arm 40. The first and second portions 47, 48 of the arm 40 may both rotate together toward the coupler 30 such that the blade 60 is raised to pass over the obstruction 19. In some embodiments, either the first or second portion 47, 48 may be fixed; with the other portion 47, 48 rotating.

The biasing device 50 will continually apply a biasing force against the arm 40 away from the coupler 30. When the upward force from the obstruction 19 is no longer being applied to the arm 40 (such as after passing over the obstruction 19), the first and second portions 47, 48 of the arm 40 will rotate away from the coupler 30 toward the ground surface 18 to return the arm 40 and blade 60 to their original, lowered positions as shown in FIG. 8C. In this manner, the blade 60 may safely pass over an obstruction 19 in the ground surface 18 without damage to the implement 14 or blade 60.

Unless otherwise defined, all technical and scientific terms used herein have the same meaning as commonly understood by one of ordinary skill in the art to which this invention belongs. Although methods and materials similar to or equivalent to those described herein can be used in the practice or testing of the blade trip system 10, suitable methods and materials are described above. All publications, patent applications, patents, and other references mentioned herein are incorporated by reference in their entirety to the extent allowed by applicable law and regulations. The blade trip system 10 may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

1. A blade trip system, comprising:
a coupler adapted to be connected to an implement, the implement being adapted to traverse a ground surface;
an arm comprising a first end and a second end, wherein the first end of the arm is rotatably connected to the coupler to rotate in either a first rotational direction or a second rotational direction;
a blade adapted to cut the ground surface, wherein the second end of the arm is connected to the blade;
a resilient compressible member connected between the coupler and the arm, wherein the resilient compressible member is resiliently compressible in a linear manner so as to bias the arm in the second rotational direction, wherein the resilient compressible member is comprised of a urethane cylinder; and
wherein the arm is adapted to rotate in the first rotational direction toward the coupler to a raised position when the blade contacts an obstruction in the ground surface such that the blade passes over the obstruction, wherein the arm is adapted to rotate in the second rotational direction away from the coupler to a lowered position after the blade has passed over the obstruction.

2. The blade trip system of claim 1, wherein the blade is comprised of a disc coulter.

3. The blade trip system of claim 1, wherein a preload of the biasing device is adapted to be adjusted.

4. The blade trip system of claim 3, comprising a bolt for adjusting the preload of the biasing device.

5. The blade trip system of claim 4, wherein the bolt is adapted to be tightened to increase the preload of the biasing device, wherein the bolt is adapted to be loosened to decrease the preload of the biasing device.

6. (canceled)

7. The blade trip system of claim 5, including a nut threadably connected to the bolt and adapted to selectively bear against the resilient compressible member.

8. The blade trip system of claim 5, wherein the resilient compressible member is positioned upon the bolt.

9. The blade trip system of claim 8, including a nut threadably connected to the bolt and adapted to selectively bear against the resilient compressible member.

10-13. (canceled)

14. The blade trip system of claim 1, wherein the resilient compressible member is elongated and compressible along a longitudinal axis thereof.

15-17. (canceled)

18. The blade trip system of claim 1, wherein the resilient compressible member comprises a nut for adjusting a preload of the resilient compressible member.

19. The blade trip system of claim 1, wherein the arm comprises a first portion and a second portion, wherein the first portion is connected to the coupler and the second portion is connected to the blade, wherein the second portion extends rearwardly from the first portion.

20. The blade trip system of claim 1, including an agricultural implement, wherein the coupler is connected to the agricultural implement. Please add the following new claims:

21. A blade trip system, comprising:
a coupler adapted to be connected to an implement, the implement being adapted to traverse a ground surface;
an arm comprising a first end and a second end, wherein the first end of the arm is rotatably connected to the coupler to rotate in either a first rotational direction or a second rotational direction;
a blade adapted to cut the ground surface, wherein the second end of the arm is connected to the blade;
a biasing device connected between the coupler and the arm, wherein the biasing device is resiliently compressible in a linear manner so as to bias the arm in the second rotational direction, wherein the biasing device is comprised of a plurality of conical spring washers; and
wherein the arm is adapted to rotate in the first rotational direction toward the coupler to a raised position when the blade contacts an obstruction in the ground surface such that the blade passes over the obstruction, wherein the arm is adapted to rotate in the second rotational direction away from the coupler to a lowered position after the blade has passed over the obstruction.

22. The blade trip system of claim 21, wherein the plurality of conical spring washers are arranged in a series configuration.

23. The blade trip system of claim 22, wherein each of the plurality of conical spring washers are concentrically aligned.

24. A blade trip system, comprising:
a coupler adapted to be connected to an implement, the implement being adapted to traverse a ground surface;
an arm comprising a first end and a second end, wherein the first end of the arm is rotatably connected to the coupler to rotate in either a first rotational direction or a second rotational direction;
a blade adapted to cut the ground surface, wherein the second end of the arm is connected to the blade;
a polyurethane cylinder connected between the coupler and the arm, wherein the polyurethane cylinder is resiliently compressible in a linear manner so as to bias the arm in the second rotational direction; and
wherein the arm is adapted to rotate in the first rotational direction toward the coupler to a raised position when the blade contacts an obstruction in the ground surface such that the blade passes over the obstruction, wherein the arm is adapted to rotate in the second rotational direction away from the coupler to a lowered position after the blade has passed over the obstruction.
